(19) United States
(12) Patent Application Publication
(10) Pub. No.: US 2025/0209077 A1
(43) Pub. Date: Jun. 26, 2025

(54) SYSTEMS AND/OR METHODS FOR CONDITIONAL DATA PARTITIONING

(71) Applicant: SOFTWARE AG, Darmstadt (DE)

(72) Inventor: Manish NEGANDHI, Bangaluru (IN)

(21) Appl. No.: 18/392,139

(22) Filed: Dec. 21, 2023

(51) Int. Cl. G06F 16/2455; G06F 16/22

(52) U.S. Cl. CPC G06F 16/24554; G06F 16/2282

(57) ABSTRACT

A partitioning scheme for a database has an associated partitioning scheme identifier, a partition-defining query, and an indication of a primary table to be partitioned. A first, primary table is associated with first and second partition types, the second being a query type for which the identifier is passed as a parameter. Each of one or more second tables has an associated partition type, namely, a query type for which the identifier is passed as a parameter. The partition-defining query includes one or more outer queries conditioned on an innermost query, the innermost query defined on the first table, each outer query querying a table other than the first. The first table is partitioned based on the first partition type. The database is updated by making a change to a partition of the first table and to a partition of each second table based on the partition-defining query.

### TECHNICAL FIELD

Certain example embodiments described herein relate to computer databases. More particularly, certain example embodiments described herein relate to techniques for conditional partitioning of data in computer databases.

### BACKGROUND AND SUMMARY

There is a wide variety of different kinds of databases used in a host of different computing fields. For example, computer scientists are familiar with relational, object oriented, and other types of databases. More and more devices are producing more and more data, and data is incredibly valuable in an interconnected world. With the proliferation of data—both in quantity and kind—the database industry has seen evolution beyond these “traditional” databases to “purpose-built” databases. Purpose-built databases are databases designed to address specific workloads. Purpose-built databases oftentimes can deal with huge amounts of data more efficiently than traditional database systems, at least in connection with the specific use cases for which they are designed. Some examples of purpose-built databases are graph databases, key-value databases, document databases, and time series databases.

As noted above, purpose-built databases are designed for specific use cases. For example, an organization planning to design a social media/social network system can make use of graph databases that can easily and efficiently handle users' connections and relationships using features provided by the graph database itself. Implementing graph databases for social media platforms/social network systems can make the technology perform and scale better.

Oftentimes, an organization can benefit from a mix of functionalities that otherwise would have been served by multiple purpose-built databases. To deal with such use cases, organizations in general either opt for a single relational database or implement multiple purpose-built solutions. Having multiple purpose-built databases can increase infrastructure requirements, require specialized expertise, and can pose complexities when integrating with other technology components. For instance, it may be difficult to share different kinds of data stored in different ways among the different databases, one database type may not be able to easily query another type of database, complicated transformations of data may be needed when sharing data among different databases, etc. Therefore, many organizations choose to implement traditional relational database solutions. In such contexts, relational database solutions may not perform as well as individual purpose-built databases, but they may enable more straightforward implementations and/or help to avoid complicated integration scenarios.

Another relatively new database design concept relates to online transaction processing (OLTP) databases, which typically use relational databases as their backbones, and which oftentimes are used to store transactional data. OTLP databases are designed to store and retrieve data with very fast response times. They are oftentimes used to handle large volumes of transactional data involving multiple users. They are therefore useful in scenarios including, for example, where a customer needs to withdraw or transfer money from one bank account to another, wants to purchase an item on an ecommerce platform and make payment via a website or mobile application, book a hotel, etc. These are some, but not all, typical OLTP database use cases.

Although OLTP databases typically are very fast when dealing with operations involving the storing and retrieving of data, the performance of the database system nonetheless oftentimes is directly correlated with the amount of data with which it is dealing. For example, there typically will be a large time disparity between retrieving a row from a database table having a few thousand rows, compared to retrieving that row from a database table having many millions of rows. Having a large amount of transaction data thus can impact the performance of the database system. Having a large amount of transaction data can also create data management issues where the storage, backup processes, regular database maintenance, and other operations have to deal with this large volume of data.

There oftentimes will be a desire to store historical data in connection with the use cases for which OLTP databases are leveraged. But OLTP databases can become very large if historical data is stored “as is” and/or is not purged or moved to a different data store. Although some organizations do purge historical data, many organizations cannot do so. For instance, some organizations may need to maintain historical data for a certain duration, e.g., for audit or other purposes. And as the amount of data stored grows over time, the performance of the database unfortunately degrades.

To deal with growing amounts of data, for OLTP, multi-use, and other use case scenarios, some relational databases offer out-of-the box database table partitioning functionality. Table partitioning is a mechanism for dividing data into multiple virtual tables called partitions. To applications and end users using the database, these partitions appear as if there is a single table in the database. However, internally, the database system divides the table into multiple parts, e.g., based on a column designated as a “partitioning key.” Partitioning is a useful feature because it can help divide large amounts of data in a table into smaller virtual tables, improve performance of SELECT and other queries that need only a subset of data, enable data to be moved quickly from a partitioned table to a separate table, provide a means for quickly purging data from a partitioned table, etc.

Most relational database management systems (RDBMSs) offer database partitioning functionality, which can help deal with tables having huge amounts of data. Partitioning oftentimes is based on a time window. For example, a table having data with a “datetime” column can be partitioned into 12 partitions, with one partition per month and one year's data being retained in a common table. By creating virtual tables, for example, partitioning can help to improve SQL and other query performance in many cases, including when data retrieval is based on a single or few partitions. In the example above, if an application tries to retrieve data for the last one month, the database may only need to read data from one partition, instead of reading data from the entire table. This approach can result in better query performance.

There are a number of different types of partitioning including, for example, RANGE partitioning, LIST partitioning, HASH partitioning, SUB-partitioning, and REFRENCE partitioning. Range partitioning partitions a table based on a range of values. In range partitioning, a range is defined with a create table or alter table command for a column so that a value inserted/updated in that column will be a part of one of the ranges defined, and so that the row will be inserted into the respective range partition. An example includes partitioning based on date ranges. Partitioning on a date column by date range is a common way to implement partitioning. The date range can be specified in terms of year, month, day, etc. Therefore, the table can be partitioned on date type column accordingly. For example, a table with a transaction_date column with a DATE datatype can be partitioned by proving the following statement while creating or altering table: PARTITION BY RANGE(MONTH (transaction_date)). In this case, a row with transaction_date defined as 1 Jan. 2023 will be inserted in partition 1, a row with transaction_date defined as 1 Feb. 2023 will be inserted in partition 2, etc.

List partitioning partitions table based on a list of values. With list partitioning, a list is defined with a create table or alter table command for a column so that a value inserted/updated in that column will be a part of one of the values defined in the list, and so that the row will be inserted into the respective list partition. An example involves partitioning on the state/province of a corresponding column. The list of states of the country is predefined while creating a table with a state/province column. A row inserted in the table will be placed in a partition based on the value of the state column, e.g., using the following command: PARTITION BY LIST (state_code). In this case, for example, a row with the state_code “AL” will be inserted in partition 1, a row with the state_code “AK” will be inserted in partition 2, etc.

Hash partitioning partitions a table based on a hash of values. With hash partitioning, an expression is defined with a create table or alter table command for a column with a hash keyword, and a value inserted/updated in that column will be inserted in a partition decided by hash function. The hash partition approach can be used to distribute data across partitions (potentially randomly), and it may be especially helpful when there is no column in the table that can clearly form an explicit partitioning key based on the data to be divided. A command that would create a partition by hashing product identifiers is as follows: PARTITION BY HASH(productID). Here, the database system will apply the hashing algorithm on the value inserted/update in the productID column, and a row will be placed in a partition based on value returned by hash column.

Sub-partitioning may be thought of as being a kind of nested partitioning or composite partitioning. It is possible to combine two kinds of partitioning in the same table. For example, a table can be partitioned on YEAR for a transaction_date field using a RANGE partition, and another partition can be applied on a DAY of the transaction_date field, e.g., using HASH partitioning while creating the table. The following example proceeds in this manner: PARTITION BY RANGE(YEAR(transaction_date)), SUBPARTITION BY HASH(TO_DAYS(transaction_date)).

With reference partitioning, it is noted that an RDMBS by design has referential integrity “built in.” That is, tables are referenced using a primary key and/or foreign key. Using referential integrity in databases helps to ensure consistent data. For example, a database system having tables for customers can have a customer_transaction table and transaction_content table. These tables can be related to each other with the customer_id field as the primary key in the customer_transaction table and a foreign key in the transaction_content table. By enforcing this relationship, the transaction_content table will not have customers who are not part of the customer_transaction table.

If there is a desire to partition the customer_transaction table while also ensuring that the same partitioning is applied to the child table transaction_content as well, reference partitioning can be used. One advantage of having reference partitioning available is that when there is an attempt to move data for the primary table's partition (in this example case, the customer_transaction table), all of the data related by foreign key for the child table transaction_content will also move automatically. Reference partitioning is available, for example, in Oracle databases, and example commands are as follows: For the table customer_transaction, PARTITION BY RANGE(YEAR(transaction_date)) and for the table transaction_content, PARTITION BY Reference (fk_cutomer_id).

Although existing partitioning schemes tend to operate well with their respective designs, improvements could be made to support conditional and declarative types of partitioning where multiple tables are involved. In real-world scenarios, for example, relational database system users often must deal with growing amounts of data and changing requirements. The data becomes “historical” quickly as new data keeps coming and as old data needs to be purged or archived. Database tables are often partitioned to speed up purge and archival process so that a database optimizer can deal with the data of an entire partition rather than by using a row-by row approach, thus (at least in theory) making the overall purge or archive process much faster. But unfortunately, data is usually divided across multiple database tables, and users therefore have to execute queries to perform retrieve from across these multiple tables data that can be qualified as historical (and thus can be subjected to archival and/or purging).

Reference partitioning can provide a partial solution to these issues. Using reference partitioning, for example, it becomes possible to execute partition-level operations against a table having a primary key and to automatically propagate operations to a table that has a foreign key defined. Yet there are a number of technical issues with respect to reference partitioning implementations. First, referential integrity must be defined on tables using primary and foreign keys. Second, by enforcing referential integrity, an application may be forced to maintain an order of insert/update operations for key columns so that referential integrity is not violated. Third, primary and foreign key columns typically either must be of same datatype or use compatible datatypes. Fourth, in at least some current implementations, only two tables can be a part of reference partitioning, as it is enforced using primary key and foreign key columns. Fifth, in at least some current implementations, there is little or no possibility for providing conditions in partitioning criteria.

Imagine, for example, a scenario where there is no common field between customer_transaction and transaction_content tables and, therefore, no relationship can be established with a key. It would be undesirable to enforce integrity between the tables and, therefore, it would not be possible to apply foreign key relationships. Assume also that there is a further transaction_tracking table, which would be good for partitioning, and that the data of all the three tables (customer_transaction, transaction_content, and transaction_tracking) is to be purged or archived together based on a certain condition. For these reasons, it would be desirable to partition each of these three tables with the same criteria. But that would not be possible with current techniques.

It is noted that the primary key and foreign key relationship can be established between two tables at a time. Although it is possible to implement multiple foreign key relationship with a single primary key, unfortunately there is no way to partition data conditionally on multiple tables and make sure that partitioning criteria is honored by each table involved in a query-based partitioning scheme using current tools.

One frequent use case for many organizations relates to the desire to archive or purge data based on conditions from multiple tables. In situations where data growth is very high, partitioning such tables becomes a common practice. And oftentimes, there is a desire to archive/purge data based on conditions from multiple tables. The following query represents a typical condition that will qualify data to be archived or purged:

| | |
|---|---|
| SELECT * | FROM Table3 WHERE Column_3_1 > 0 AND Column_3_2 IN |
| (SELECT Column_2_1 | FROM Table2 WHERE Column_2_1 = ‘PROCESSED’ AND |

Column_2_2 IN

| | |
|---|---|
| (SELECT Column_1_1 | FROM Table1 WHERE Column_1_2 < ‘30-May-2022’ ) ) |

Using the existing database system partitioning schemes discussed above, the organization would need to partition each of the three tables differently. And even after doing so, the partitioned data will not be consistent as per the above given condition. The organization would, for example, need to implement range partitioning for Table1; however, if Table2 and Table3 do not have date columns, they cannot be partitioned like Table1. Furthermore, it will be possible for Table1 to hold in a single partition many, many rows for which a transaction date is before a defined date; however, it may not be technically feasible to ensure that all of these rows will have a status of “PROCESSED” in a single partition for Table2 so that when the Table1 partition is archived or purged, a similar partition for Table2 can also be archived or purged without having to worry about data consistency.

One current database implementation offers refence partitioning in which partitioning for two tables can be linked and in which data will be consistent across the partitions of the two tables. Unfortunately, however, the prerequisite is to have a primary and foreign key relationship. As per the example above, if partitioning needs to be implemented, it should be on the DATE column for Table 1 and the status column for Table2. But one cannot establish a primary key and foreign key relationship between these two columns because they hold different datatypes, and even their values are very different from each other. As such, the implementation of reference partitioning, although seemingly a step forward, unfortunately is limited by the requirement to use primary and foreign keys. There is no way to implement truly conditional partitioning, out-of-the-box, e.g., for conditionally partitioning data automatically when multiple tables are involved.

Referring again to OLTP databases, and further to the partitioning discussion above, data that is considered “historic” for an organization typically is a good candidate for partitioning. For example, if a transaction_date column in a table is designated as a partitioning key for use with a monthly partitioning scheme, for one year of data, the database system will have 12 partitions created for the table, one for each month. If an SQL or other query tries to process data for the month of March, for example, the database is able to read only the one partition for March, which potentially can eliminate from consideration (e.g., the search space) a lot of unwanted or irrelevant data and in turn speed up the query execution for large tables. Similarly, in this case, when a user wants to move or purge data for the month of March, the user can deal with just this one partition rather than the entire dataset. Building on this example, if an organization wants to retain only 12 months of data, older partitions can be purged with a single database command, which can be implemented considerably faster than purging data row-by-row in batches.

And as noted above, some database systems also have a sub-partitioning feature, e.g., where it is possible to partition first on a single column and secondarily partition on a second column in the same table. It therefore becomes possible to expand the criteria of partitioning to multiple columns. Partitioning and sub-partitioning can be helpful in some situations. Yet there are cases when an organization's requirements and/or database data models mean that a SQL or other query is needed to join two or more tables on various columns, with the result of the query qualifying as historical data. As an example, there may be a transaction_date in two different tables along with a status column in a third table, and historical data could be defined where the transaction_date is over a month old and a status is set to “processed” for the same transaction_ids residing in both of the tables. In this case, it unfortunately is not possible to partition historical data using some existing database systems and some existing partitioning/sub-partitioning schemes. The reason is because the current partitioning mechanism for at least some existing database systems is designed to work at the column level only. In other words, existing partitioning/sub-partitioning schemes generally do not work at a query level or in connection with a condition passed in a query level. Because of these partitioning limitations, it unfortunately is not possible to partition data in multiple tables with a query criteria and, therefore, partitioned tables cannot be moved (e.g., for archival or other purposes) or purged conditionally. Database systems therefore process data row-wise or batch-wise (but not partition-wise) in such cases. This processing approach can lead to delays, especially where OLTP databases are implemented.

Certain example embodiments help address the above-described and/or other concerns. For example, certain example embodiments improve OTLP databases and/or the relational databases on which they are built.

One aspect of certain example embodiments relates to improving database partitioning and sub-partitioning techniques, e.g., for relational databases and databases that are built using relational databases such as OTLP databases.

Another aspect of certain example embodiments relates to improvements to reference partitioning related techniques. For example, an aspect of certain example embodiments relates to providing support for conditional and declarative types of partitioning where multiple tables are involved.

Another aspect of certain example embodiments relates to the ability to partition data conditionally on multiple tables and make sure that partitioning criteria is honored by each table involved in QUERY partitioning scheme.

In certain example embodiments, conditional table partitions are created instead of (or in addition to) column-wise non-conditional partitions. Certain example embodiments involve one or more tables being within partitioning criteria. This approach advantageously simplifies partitioning in scenarios where, for example, it would be desirable to partition data that resides in multiple columns of multiple tables.

In certain example embodiments, a method of managing a database stored to a data store is provided. A definition of a partitioning scheme is received, with the definition of the partitioning scheme having associated therewith a partitioning scheme identifier, a partition-defining query, and an indication of a primary table to be partitioned. A definition of a first table is received, with the first table being the primary table, with the definition of the first table having associated therewith at least first and second partition types by which the first table is to be partitioned, and with the second partition type being a query type for which the partitioning scheme identifier is passed as a parameter. A definition of one or more second tables is received, with each said second table being defined so as to have associated therewith a partition type by which the respective second table is to be partitioned, and with the partition type of each said second table being a query type for which the partitioning scheme identifier is passed as a parameter. The partition-defining query includes one or more outer queries conditioned on an innermost query, with the innermost query being a query on the first table, each of the one or more outer queries being a query on a table in the database other than the first table. The first table is partitioned based on the first partition type. The database is updated in response to an operation performed thereon. The updating includes making a change to a partition of the first table and to a partition of each said second table based on an outcome of the partition-defining query.

In certain example embodiments, there is provided a non-transitory computer readable storage medium storing instructions that, when executed by at least one processor, perform operations comprising: receiving a definition of a partitioning scheme for a database, the definition of the partitioning scheme having associated therewith a partitioning scheme identifier, a partition-defining query, and an indication of a primary table to be partitioned; receiving a definition of a first table, the first table being the primary table, the definition of the first table having associated therewith at least first and second partition types by which the first table is to be partitioned, the second partition type being a query type for which the partitioning scheme identifier is passed as a parameter; receiving a definition of one or more second tables, each said second table being defined so as to have associated therewith a partition type by which the respective second table is to be partitioned, the partition type of each said second table being a query type for which the partitioning scheme identifier is passed as a parameter, wherein the partition-defining query includes one or more outer queries conditioned on an innermost query, the innermost query being a query on the first table, each of the one or more outer queries being a query on a table in the database other than the first table; partitioning the first table based on the first partition type; and updating the database in response to an operation performed thereon, wherein the updating includes making a change to a partition of the first table and to a partition of each said second table based on an outcome of the partition-defining query.

In certain example embodiments, a data management system comprises a data store and a database stored to the data store. A memory is coupled to at least one hardware processor configured to perform operations comprising: receiving a definition of a partitioning scheme for the database, the definition of the partitioning scheme having associated therewith a partitioning scheme identifier, a partition-defining query, and an indication of a primary table to be partitioned; receiving a definition of a first table, the first table being the primary table, the definition of the first table having associated therewith at least first and second partition types by which the first table is to be partitioned, the second partition type being a query type for which the partitioning scheme identifier is passed as a parameter; receiving a definition of one or more second tables, each said second table being defined so as to have associated therewith a partition type by which the respective second table is to be partitioned, the partition type of each said second table being a query type for which the partitioning scheme identifier is passed as a parameter, wherein the partition-defining query includes one or more outer queries conditioned on an innermost query, the innermost query being a query on the first table, each of the one or more outer queries being a query on a table in the database other than the first table; partitioning the first table based on the first partition type; and updating the database in response to an operation performed thereon, wherein the updating includes making a change to a partition of the first table and to a partition of each said second table based on an outcome of the partition-defining query.

According to certain example embodiments, the first partition type may be a range or list type partition.

According to certain example embodiments, two or more second tables may be included in the database, and the partition-defining query may be nested such that a first outcome of a first query on one of the second tables is conditioned on an outcome of the innermost query, and such that a second outcome on a second query on another one of the second tables is conditioned on the first outcome.

According to certain example embodiments, each definition of each first table may be provided in a respective create table statement.

According to certain example embodiments, changes may be made to the second table(s) provided that a flag indicates that changes are to be cascaded thereto.

According to certain example embodiments, the operation may be an insert or update data operation.

According to certain example embodiments, the operation may be an archive and/or purge operation where at least some data from the first and second tables is to be archived and/or purged. In such cases, for example, a first set of data may be archived and/or purged from a first partition of the first table and a second set of data may be archived and/or purged from a counterpart partition of the second table(s).

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is an example database including multiple tables, multiple columns, and an example SQL query;

FIG. 2 is a flowchart showing the query-based partitioning approach of certain example embodiments;

FIG. 3 provides an example of tables and data that may be included therein for helping to illustrate the operation of certain example embodiments;

FIG. 4 is a flowchart showing a process for defining a partitioning scheme in accordance with certain example embodiments;

FIG. 5 shows the example shipment_details table from FIG. 3 with an indicator of the partition to which each entry (row) belongs shown, in accordance with certain example embodiments;

FIG. 6 is a flowchart showing a process for determining partitions for the payment_details table shown in FIG. 3, in accordance with certain example embodiments;

FIG. 7 shows the example payment_details table from FIG. 3 with an indicator of the partition to which each entry (row) belongs shown, in accordance with certain example embodiments;

FIG. 8 is a flowchart showing a process for determining partitions for the order_details table shown in FIG. 3, in accordance with certain example embodiments;

FIG. 9 shows the example order_details table from FIG. 3 with an indicator of the partition to which each entry (row) belongs shown, in accordance with certain example embodiments;

FIG. 10 is a block diagram including an example RDBMS that may be used in connection with certain example embodiments.

### DETAILED DESCRIPTION

As will be appreciated from the description above, there are technical challenges in dealing with growing amounts of data where database technology is concerned. Database partitioning is one technical solution to help address technical challenges associated with large amounts of data. For instance, in a scenario where data in a table is growing fast, partitioning can help ensure that that performance of the database does not degrade in proportion to amount of data. Partition-level operations like move, truncate, and drop, work with the metadata of a table and can perform much faster than row-by-row or batch-wise operations conducted on non-partitioned tables.

Consider the following example of the work a database system would do for row-by-row or batch-wise operations, compared to partition-level operations. For the former, the database looks at the data (stored in a data page or the like) to determine each qualifying row that needs to be processed. This operation consumes input/output (I/O) and CPU resources. If a table being purged has indexes associated, the database locates rows in the index (stored in an index page or the like) and deletes the index entries as well, or at least marks those rows for deletion. In the case of OLTP databases, OLTP databases record each change performed in database in a change log (e.g., oftentimes named Transaction Log). Typically, this change log is stored in memory and flushed to disk after each commit or checkpoint. Database operations like row-by-row changes cause frequent commits, and each commit in turns causes disk I/O operations. Batch-wise operations can reduce commit frequency, but frequent commits can still happen if there are many of batches to be committed. Furthermore, OLTP databases maintain high concurrency and, as a result, most OLTP databases make use of Multi Version Concurrency Control (MVCC) techniques. In order to maintain high concurrency, depending on what database isolation level is in place, MVCC may create a copy of rows that are currently being processed (e.g., deleted/updated) so that other concurrent users can read the same rows without being blocked. The larger the number of rows to be processed, the longer the operations mentioned will take, as the database system needs to do extra work to accomplish these tasks.

This is readily contrastable with the work a database system does for partition-level exchange, truncate, and drop operations. In this regard, the database system stores partitioned data in a separate file or other structure in an operating system and maintains metadata about partitions in system/catalog tables. The database uses system tables to store and track information about table partitions. For example, Table with monthly Range PARTITION will have one range stored for each month along with its partition name in system table. Thus, 12 rows will be stored in a system table for each month's partition for a year. If the first 6 months' worth of data needs to be purged or truncated, the database system first deletes or updates six rows from the system table for the six partitions, and then deletes six files from operating system. The actual removal of the partition's data file often happens asynchronously. Typically, there is no data or index page lookup required, and typically no frequent commit operations or MVCC is needed. In a similar vein, no row-by-row or batch-wise extra logging generally is required for a Transaction Log or the like. Therefore, partition-level operations are significantly faster compared to row-by-row or batch-wise operations.

Partitioning thus can be helpful in a wide variety of contexts. Data in relational databases oftentimes is in (an at least partially) normalized form, e.g., where data related to a single use case or event is spread across a number of different tables. Therefore, although it is possible to partition and conduct partition-level operations against a table that is growing fast, it nonetheless can be technically challenging to deal with related data lying in several tables. Indeed, it can be technically challenging to ensure that related data is partitioned in a manner suitable for conducting partition-level operations not only on a single table but on multiple (and potentially all) related tables cohesively. That is, in relational databases, for example, tables are related with each other either explicitly using a primary key and foreign key or implicitly by application. So if data from one table is purged, data for the other related table(s) might not be very useful or have an easily discerned meaning as the relation(s) may be lost. Accordingly, when partition-level operations like truncate or drop are executed on one table, such operations might render data from other related tables less useful and/or with a questionable meaning. In existing database systems, this residual data is dealt with manually, which is potentially time-consuming and resource-intensive. It would be advantageous to deal with the data being purged and this residual data all at once.

Certain example embodiments help address these and/or other concerns related to computer database technology. More particularly, certain example embodiments provide techniques where a database is able to conditionally partition a table and propagate the condition to multiple tables. Thus, using the approach of certain example embodiments, it becomes possible to redefine or reimagine database partitioning as a declarative concept.

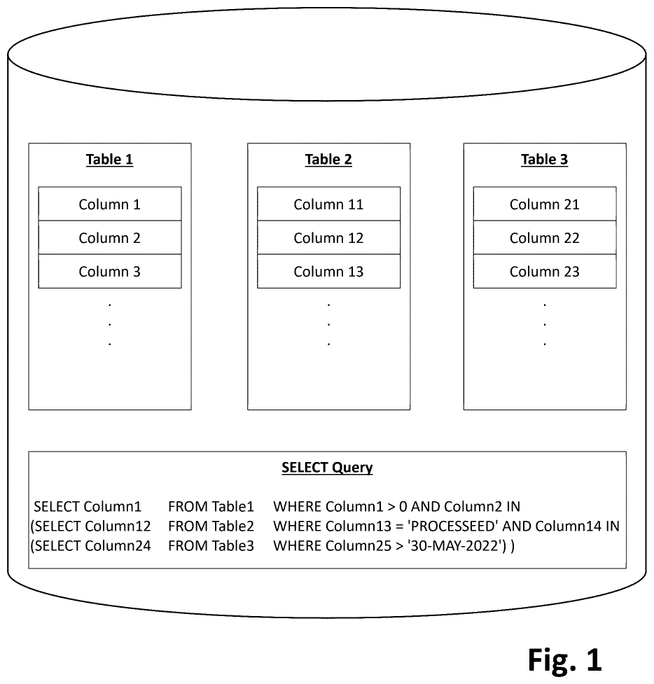

To help understand the approach of certain example embodiments, consider FIG. 1, which is an example database including multiple tables, multiple columns, and an example SQL query. More particularly, in FIG. 1, there are three tables, and columns are distributed across these three tables. The SQL query in the FIG. 1 example is a SELECT query, which is trying to fetch data from Table1 using a subquery based on criteria applied to Table2, and there is another subquery that fetches data from Table2 based on criteria applied to Table3 that is passed on the outermost query.

The type of SELECT query shown in the FIG. 1 example is very commonly used for a variety of use cases, at least in the sense that it is common to select data from one table based on data from one or more other tables. With the FIG. 1 example, if one or more of the three tables is growing quickly, then partitioning may be desirable. However, the presence of the SELECT query indicates that a combination of data from multiple tables may need to be archived or purged at some point. That is, when archiving and purging operations are to be performed, data will be selected from Table1 based on data from Table2 and Table3 as indicated by the FIG. 1 example SELECT query. If Table1 is partitioned and data of one of its partitions is archived, it is possible that related data is still present in Table2 and Table3 and is either not purged or archived, and it would be desirable to simultaneously archive and purge the data from Tables2 and Table3. But the presence of this conditionality would mean that, using conventional techniques, the combination of data may not be fully and properly archived and/or the combination of data may not be fully and properly purged. The former could lead to improper or incomplete archiving which could hamper audit, rollback, and/or other operations. The latter could result in erroneous entries that could take up resources and, over time, degrade the performance of the database.

Certain example embodiments provide the ability to define a partition for a query on multiple tables. That is, certain example embodiments are able to partition a table by using a query that is a conditional SELECT query, e.g., involving multiple tables. Furthermore, in certain example embodiments, a partition query that involves a SELECT query on multiple tables along with partitioning methods like RANGE and LIST partitioning can be defined, and a primary table (PrimaryTable) for the query also can be defined. The PrimaryTable of the query in certain example embodiments acts as a master table for the partitioning scheme as will become clearer from the description below. Additional partitioning operations (such as, for example, move partition, truncate partition, alter partition, etc.) can be applied to the PrimaryTable and propagated automatically to the other tables created with the partitioning scheme when called.

### Example Implementation

Details regarding an example implementation will now be provided. It will be appreciated that the code snippets, query languages, etc., are provided by way of example and without limitation unless claimed. In certain example embodiments, a partitioning scheme is defined using a declarative. For example, with SQL, a SELECT query can be declared to define the partitioning scheme in certain example embodiments. Once the query is named and declared, it can be used as a reference while creating tables in table definitions.

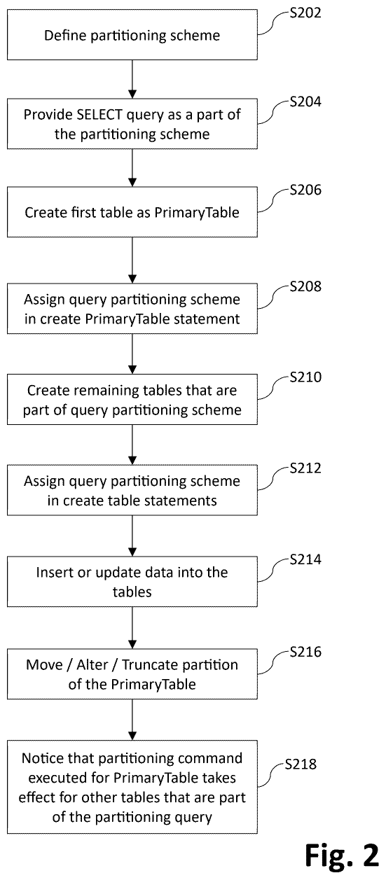

As an overview, FIG. 2 is a flowchart showing the query-based partitioning approach of certain example embodiments. In step S202, a partitioning scheme is defined with a declarative statement. In this regard, in step S204, a SELECT or other query is provided as a part of the partitioning scheme. It will be appreciated that the creation of the partitioning scheme in step S202 may be performed in a declarative manner (e.g., Create Partitioning Scheme may be used in a manner similar to a SQL clause like Create Table), whereas step S204 is more indicative of supplying a SELECT or other query with this sort of statement (e.g., the Create Partitioning Scheme statement). Taking advantage of the approach of certain example embodiments, this SELECT query may have nested queries/subqueries, such that the outcome of one depends on another. There is thus some conditionality imparted on the SELECT query. The first table is created as the PrimaryTable in step S206. The query partitioning scheme identifies the PrimaryTable statement. The create table definition for the table that is the PrimaryTable identifies the partitioning scheme in step S208. In step S210, the remaining tables that are part of the query partitioning scheme are created, with the query partitioning scheme being identified in the create table statements for those remaining tables, as indicated in step S212. Data is inserted into or updated for the tables in step S214. Move, alter, truncate, and/or other partition-related commands are permitted with regard to the PrimaryTable in step S216. Step S218 notes that the partitioning command executed for the PrimaryTable has an effect for the other tables that are part of the partitioning query, and the changes automatically propagate to the other tables. For example, if data from the PrimaryTable is to be archived, related data from one or more other tables will be archived as well, provided that it is appropriate to do so. It will be appreciated that the PrimaryTable is created first because it will define the “base partitioning” scheme (e.g., RANGE or LIST partitioning) via which data will be partitioned in PrimaryTable, and the query will be associated with the other tables in the database. Partitioning the PrimaryTable enables the database system to “know” what base partition a given row should belong to, e.g., if a row belongs to a particular partition in the PrimaryTable, rows for other tables (that are not the PrimaryTable) will also correspond to the same partition. Further details of the example operations shown in FIG. 2 is provided below.

### Example Partitioning Scheme Configuration

The partitioning scheme defines the partitioning approach to be taken. The partitioning scheme indicates that the partition is defined with a query such as, for example, a SQL SELECT query. Existing database technologies make use of partitioning at the column level, whereas certain example embodiments are able to create a partitioning scheme in which partitioning can be defined using a SELECT query using multiple tables. Below is an example partitioning scheme definition that builds on the example discussed in the background.

DEFINE PARTITIONING SCHEME PART_Q1 BY QUERY AS

| | |
|---|---|
| [ SELECT * | FROM Table3 WHERE Column_3_1 > 0 AND Column_3_2 IN |
| (SELECT Column_2_1 | FROM Table2 WHERE Column_2_1 = ‘PROCESSED’ AND |

Column_2_2 IN

| | |
|---|---|
| (SELECT Column_1_1 | FROM Table1 WHERE Column_1_2 > ‘30-May-2022’ ) ) |

WITH PrimaryTable=Table1 ]

This approach advantageously enables partitioning to be defined declaratively as a query. That query can use or otherwise reference multiple tables, and single or multiple conditions can be passed for each table that forms a part of the partition-defining query. And advantageously, partition-level operations can be performed on the defined PrimaryTable, which will enable relevant partition-level operations to be propagated automatically to non-primary tables defined in partitioning query.

Example Primary Table Creation with Partitioning Scheme as a Query Parameter

As will be appreciated from the previous section, a PrimaryTable is designated in connection with the definition of the partitioning scheme. In that example, Table1 is designated as the Primary Table for the partitioning scheme named PART_Q1. When defining Table1, query name and RANGE/LIST partitioning are passed to the database system with a PARTITION BY clause, and the database system will recognize the partition scheme defining query based on the query name. In this example, Table1 is the PrimaryTable, and it will be partitioned based on the range/list defined during table creation. It is noted, however, that other tables specified in the partitioning scheme will follow query criteria given in the partitioning scheme. In other words, in certain example embodiments, whereas the Primary Table is partitioned by either range or list criteria, other tables follow partitioning by query. By doing so, the database system can understand which row belongs to which partition when data is inserted or updated in the PrimaryTable. As explained in greater detail below, when data is inserted into other tables, query partitioning will make use of the query defined along with the table and determine which partition the PrimaryTable's data belongs to and will assign the same partition to the other table as well. The following is an example of Table1 being created:

```
CREATE TABLE Table1 (
  id INT,
  Column_1_1 VARCHAR(20),
  Column_1_2 DATETIME
  Column_1_3 VARCHAR(20),
  Column_1_4 INT
  ) PARTITION BY RANGE (MONTH (Colum2)) QUERY(PART_Q1)
```

Table1 is defined as the primary table in the partitioning scheme configuration step discussed above. The partitioning criteria of Table1 is by RANGE and then by QUERY. According to this definition, while data will be partitioned based on RANGE for Table1, a query is also attached with the “partition by” clause. Therefore, data for tables Table2 and Table3 referenced in the identified query (PART_Q1) will be partitioned based on a condition given in the query plus the relevant Table1 partition.

By defining the QUERY logic along with the RANGE partition for the PrimaryTable Table1, the database system understands that this partition is not only based on range but also is part of the defined QUERY partition and, therefore, any partitioning level operations can be cascaded to all the tables that are part of QUERY automatically if desired. For example, an extra configuration parameter or the like (e.g., a cascade_query_partition flag as discussed in greater detail below) may be exposed to, and set by, an end-user of a database system. By reading this parameter, the database system can determine whether partitioning operations should be cascaded automatically to other related tables that are part of the query-based partitioning.

### Example Non-Primary Table Creation Using Partitioning Scheme as a Query Parameter

The tables that are not the PrimaryTable are created, and the partitioning scheme is attached to their definitions, similar to the above. The following examples show the creation of two different tables, namely, Table2 and Table3, to which the partitioning scheme PART_Q1 is attached as a query in a partition by clause. That is, the query name is passed with the PARTITION BY clause, and the database system recognizes the query based on the query name and criteria passed with the QUERY condition.

```
CREATE TABLE Table2 (
  id INT,
  Column_2_1 VARCHAR(20),
  Column_2_2 VARCHAR (20),
  Column_2_3 VARCHAR (20),
  Column_2_4 VARCHAR (10)
  ) PARTITION BY QUERY(PART_Q1);
CREATE TABLE Table3 (
  id INT,
  Column_3_1 INT,
  Column_3_2 VARCHAR (20),
  Column_3_3 VARCHAR (20),
  Column_3_4 VARCHAR (10) ,
  Column_3_5 DATE
  ) PARTITION BY QUERY(PART_Q1);
```

It is noted that reference partitioning enforces primary and foreign key constraints, which imposes restrictions as noted above. In certain example embodiments, primary and foreign key constraints are not enforced, which allows users to partition more than two tables at a time with multiple conditions in each, and the archiving/purging conditions will work in tandem.

### Example Insertion of Data in Partitioned Tables

Data goes into a partition in a partition table based on the partitioning criteria when data is inserted or updated. In certain example embodiments, data will be inserted/updated into a particular partition of the table in accordance with predefined rules. First, data for the PrimaryTable will be inserted or updated in a partition based on range or list partitioning criteria defined while creating or altering the Primary Table definition. Second, data for other referenced tables will be inserted/updated in a partition based on the data inserted in a particular partition for the PrimaryTable and based on conditions given in the QUERY partitioning scheme.

### Example Partition-Level Operations Performed on the PrimaryTable

Execution of a DROP, TRUNCATE, or other command, may be dependent on a flag indicating whether the cascading should take place being set to true. For example, if there is a desire to purge data of one partition from the PrimaryTable, the following command can be executed on Table1: ALTER TABLE Table1 DROP PARTITION Partition1. This command will not only purge the data from Table1.Partition1, but also purge the corresponding Partition1 for Table2 and Table3 if the cascade flag is set to true.

Another typical use case for partitioning for archival is when the partition is moved to another table using the EXCHANGE partition command. This command is used to swap an existing partition of a partitioned table with a brand new table. If the QUERY partitioning of certain example embodiments is implemented and cascading is flagged to be true, data for multiple tables will move to new tables as appropriate. Consider, for example, the command: ALTER TABLE Table1 EXCHANGE PARTITION part_january2023 to Table1_archive_part_january2023. This will move all the data from Table1 for partition part_january2023 to a new table named Table1_archive_part_january2023. If the tables are part of a QUERY partitioning scheme and if the parameter specifying that cascading is set to true, the relevant partition of each table associated with the query partitioning will also move to a new table. A naming convention may be used to help facilitate the transfer. For example, a naming convention like Tablename_archive_partition_name may be used in certain example embodiments.

### Example Result of Partition-Level Operations Performed on Non-Primary Tables

In certain example embodiments, partition operations on an “upstream” table automatically affect entries in “downstream” tables belonging to the same partition. For example, operations on a PrimaryTable can affect other tables. Differently stated, an operation on an outer query may trigger changes to an inner- or sub-query.

It is noted, however, that there may be instances where this feature need not be enabled. For example, partitioning first may help to reorganize data, which may already be beneficial in itself, e.g., for reducing access times or other purposes. Extending the effect of the partitioning scheme to further actions like dropping rows in downstream tables thus may be optional in some instances and may be controlled via the presence of a parameter or the like.

In instances where this feature is enabled, in certain example embodiments, as Table1. Partition1 is dropped, rows of Table1 are dropped and corresponding rows for Table2 also will be dropped as Table2.Partition1 will be dropped automatically, e.g., if a parameter such as cascade_query_partition is set to TRUE (or a semantic equivalent thereof). Likewise, if Table3 has a partition1 with corresponding related data that is available in Table1.Partition1 and Table2.Partition1, that also will be dropped.

Because of the way that the query partitioning scheme is defined in this example, Table2.Partition1 and Table3.Partition1 will only have data that is related to Table1.Partition1 and that also satisfies condition for PART_Q1 query. Therefore, the related data can be purged in tandem with the tables that are part of query PART_Q1.

### EXAMPLE

The following example assumes the presence of three different tables, namely, shipment_details, payment_details, and order_details. The shipment_details table tracks shipment dates and details, and it is designated as the PrimaryTable. The payment_details table tracks payment dates and details for orders placed. The order_details table tracks order details and status. It will be appreciated that more or fewer tables may be used in different examples, which may relate to the same or different use cases.

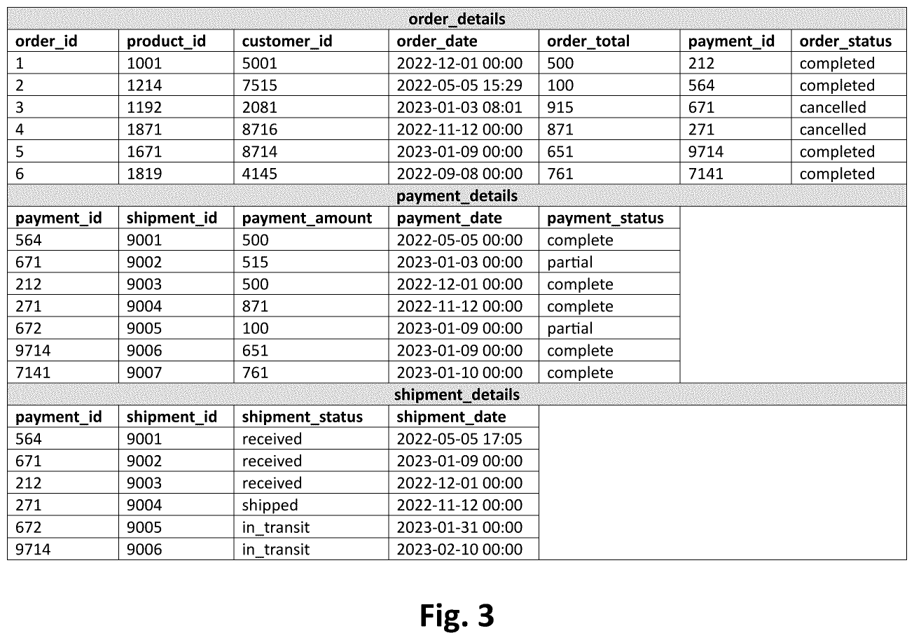

FIG. 3 provides an example of these tables' structures and data that may be included therein for illustrative purposes. The order_details table contains orders with dates stored in the order_date column. The payment_id column is in common with the payment_details and shipment_details tables, as well. The payment_details table contains payment details for respective orders, along with payment_id and payment_status columns. The shipment_id column is in common with the shipment_details table. The shipment_details table is a primary table in this example, as noted above.

The organization that manages these tables desires to archive or purge data from them, e.g., as the data continues to grow, as doing so can help maintain database performance and potentially enable faster query response time. Conventional approaches might implement a separate partitioning mechanism for each table, but doing so would be cumbersome to set up initially, and it would be difficult and potentially impossible to keep data consistent when archiving or purging data. In contrast, certain example embodiments partition data based on a query that allows the data to be archived partition-wise without having to separately and independently manage data consistency.

For instance, the approach of certain example embodiments makes it easy to implement partitioning that can handle data consistency while archiving and purging data, e.g., in connection with a desire to archive all such data where, for example, the data is older than a defined period and other details are met. For example, the organization can have a requirement to archive all such data where the order_date is older than the current calendar year 2023, the payment_status is complete, and the order_status is complete (indicating that the shipment has been received).

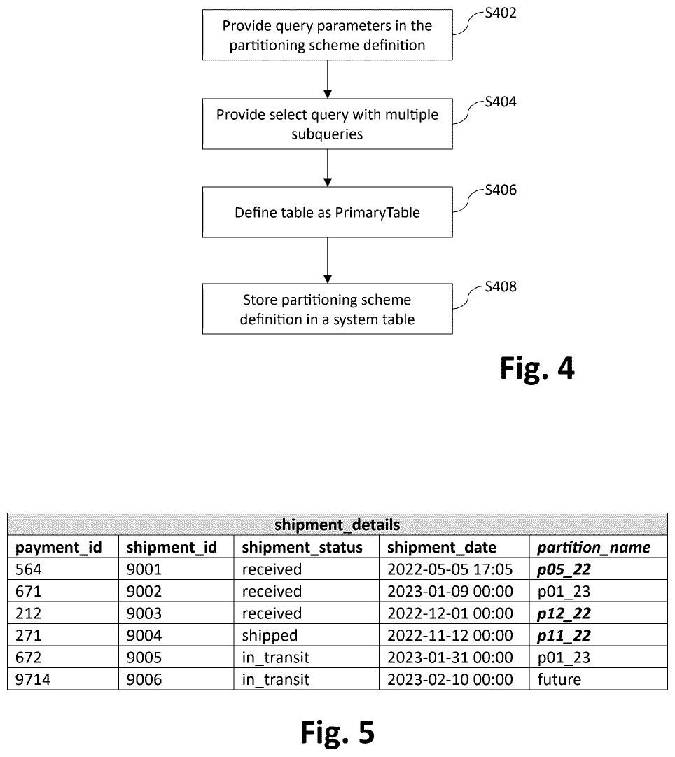

FIG. 4 is a flowchart showing a process for defining a partitioning scheme in accordance with certain example embodiments. In step S402, the partitioning scheme is defined using query parameters. The overall declarative approach is explained in detail above. In step S404, a select query with multiple subqueries is provided as a part of this definition. For example, the following SQL statement may be used to accomplish the desired archival:

```
SELECT *
FROM order_details od
WHERE order_status = ‘completed’
  AND payment_id IN (
    SELECT payment_id
    FROM payment_details pd
    WHERE pd.payment_status = ‘complete’
      AND shipment_id IN (
        SELECT shipment_id
        FROM shipment_details sd
        WHERE shipment_date < ‘2023-01-01’
        )
    )
```

In other words, this SQL query is written so as to retrieve the data desired for archiving and purging. It is noted that the table being used in the subquery has a matching column with the outer table based on which database system can join theses tables. As will be appreciated by those skilled in the art, the database system internally may convert the subquery to a join operation.

In step S406, a table is set as the PrimaryTable. That is, once the query in step S404 is written, details can be attached to that query to identify the primary table. The following is an example:

```
[ SELECT *FROM order_details od WHERE order_status = ‘completed’ AND
  payment_id IN (SELECT payment_id FROM payment_details pd WHERE
  pd.payment_status = ‘complete’ AND shipment_id IN (SELECT
  shipment_id FROM shipment_details sd WHERE shipment_details < ‘2023-
  01-01’) ) WITH PrimaryTable=shipment_details]
```

The select statement partitions based on order details where there are completed orders that have been paid and where the shipment was made prior to Jan. 1, 2023. This example shows the nested or multiple subquery approach applicable in certain example embodiments. It will be appreciated that different criteria for these or other tables may be used in different example embodiments.

In this example, and relevant to step S406, the PrimaryTable is defined in connection with the select query. In certain example embodiments, the Primary Table is defined to use range and/or list based partitioning. As will be appreciated from the description above, the PrimaryTable (which in this case is the shipment_details table) will be the table on which the overall partitioning scheme is based.

In step S408, the partitioning scheme is stored in a system table or other structure. If the partitioning scheme being defined is the first partitioning scheme for the database, then the system table may be newly created. By storing details regarding the partitioning scheme to a system table, the partitioning scheme can be referenced for subsequent partitioning operations. In this example, the query partitioning scheme is called PART_Q1.

Once the query partitioning scheme is created, it is attached to the non-primary tables during table definition. Along with the query partitioning scheme, range or list partitioning is defined for the PrimaryTable. Thus, it will be appreciated that defining RANGE/LIST partitioning for the primary table defines how data will be partitioned for the PrimaryTable, and attaching the query partitioning scheme defines how data will be partitioned for tables referenced in partitioning scheme.

The following shows code for PrimaryTable creation, where query-based partitioning is attached to the creation statement.

CREATE TABLE shipment_details (

| | |
|---|---|
| payment_id | int(11), |
| shipment_id | int(11), |
| shipment_status | varchar(20), |
| shipment_date | timestamp ) PARTITION BY RANGE |

(UNIX_TIMESTAMP(‘shipment_date‘))
(
PARTITION p03_22 VALUES LESS THAN (UNIX_TIMESTAMP(′2022-04-01′)),
PARTITION p04_22 VALUES LESS THAN (UNIX_TIMESTAMP(′2022-05-01′)),
PARTITION p05_22 VALUES LESS THAN (UNIX_TIMESTAMP(′2022-06-01′)),
PARTITION p06_22 VALUES LESS THAN (UNIX_TIMESTAMP(′2022-07-01′)),
PARTITION p07_22 VALUES LESS THAN (UNIX_TIMESTAMP(′2022-08-01′)),
PARTITION p08_22 VALUES LESS THAN (UNIX_TIMESTAMP(′2022-09-01′)),
PARTITION p09_22 VALUES LESS THAN (UNIX_TIMESTAMP(′2022-10-01′)),
PARTITION p10_22 VALUES LESS THAN (UNIX_TIMESTAMP(′2022-11-01′)),
PARTITION p11_22 VALUES LESS THAN (UNIX_TIMESTAMP(′2022-12-01′)),
PARTITION p12_22 VALUES LESS THAN (UNIX_TIMESTAMP(′2023-01-01′)),
PARTITION p01_23 VALUES LESS THAN (UNIX_TIMESTAMP(′2023-02-01′)) ,
PARTITION future VALUES LESS THAN MAXVALUE
) PARTITION BY QUERY (PART_Q1)

The following shows code for the payment_details table creation, where query-based partitioning is attached to the creation statement.

| CREATE TABLE payment_details ( | |
|---|---|
| payment_id | int(11), |
| shipment_id | int(11), |
| payment_amount | int(11) , |
| payment_date | timestamp, |
| payment_status | varchar(20) ) PARTITION BY |
| | QUERY(PART_Q1) |

The following shows code for the order_details table creation, where query-based partitioning is attached to the creation statement.

CREATE TABLE order_details (

| | |
|---|---|
| order_id | int(11) , |
| product_id | int(11) , |
| customer_id | int(11) , |
| order_date | timestamp, |
| order_total | int(11) , |
| payment_id | int(11) , |
| order_status | varchar(10) ) ) PARTITION BY QUERY(PART_Q1) |

When data is inserted/updated in the shipment_details table, it will be partitioned based on the range defined during table creation. FIG. 5 shows the example shipment_details table from FIG. 3 with an indicator of the partition to which each entry (row) belongs shown, in accordance with certain example embodiments. In this example, the range is defined so that there is a partition for each month of each year. Thus, based on the shipment_date month and year values, data is inserted into the appropriate partition that is defined while creating the table. It will be appreciated that the partition_name column is provided for illustration in this example. In certain example embodiments, the database system may store partitioning-related metadata in system tables or other structures and thus may know which row belongs to which partition based on this metadata without the use of an extra column. In certain example embodiments, however, a dedicated partition column similar to that shown in FIG. 5 may be provided.

In existing RDBMS systems, when a partition is created for a table, the partition definition and related metadata is stored in a system table or other structure. This metadata is referenced by the database system each time there is a data retrieval operation prompted by a SELECT command, data manipulation language (DML) call such as INSERT/UPDATE/DELETE, etc. In certain example embodiments, partitioning metadata may be stored in multiple system tables. For example, the table USER_PART_TABLES may include information about the partitioned tables in the user's schema, including: table name; partitioning type (range, list, hash, composite, etc.); partitioning key columns; high and low values for range partitions; a list of values for list partitions; etc. The USER_TAB_PARTITIONS table may store detailed information about individual partitions within a partitioned table, including: partition name, high and low values for range partitions, a list of values for list partitions, storage information (e.g., tablespace, file name), etc. These tables or other structures may be adapted to store QUERY-based partition definitions and associated parameters. For example, the USER_PART_TABLES may be used to store the query-based partition name and query, etc. In general, database systems usually store parameters in a separate system table or in a file on operating system

While defining the partitioning scheme, the primary table shipment_details query is the innermost subquery in this example:

SELECT shipment_id FROM shipment_details sd WHERE
sipment_date < ‘2023-01-01’

Starting with the FIG. 3 data, this query retrieves three rows in this example. The rows retrieved based on this query will be shipment_ids placed in the respective month's partitions, which are displayed in the FIG. 5 table for shipment_ids 9001, 9003, and 9004 as partition names p05_22 (for May 2022), p12_22 (for December 2022), and p11_22 (for November 2022), respectively.

In addition to defining a range partition for the table shipment_details, there is also additional partitioning in this example. This partitioning is PARTITION BY QUERY, and the query name PART_Q1 attached the three tables in this example.

Consider now a data insert/update operation for the payment_details table. Data inserts/updates for the payment_details and order_details tables are handled somewhat differently compared to the inserts/updates for the PrimaryTable. The shipment_details and payment_details tables have a common column shipment_id, and the condition is defined accordingly in PART_Q1 query statement. Therefore, when there is an insert or update in the payment_details table, the database system executes a query for the payment_details table along with a subquery for the shipment_details table, as defined in PART_Q1 and as given below:

```
SELECT payment_id FROM payment_details pd WHERE .payment_status =
  ‘complete’ AND shipment_id IN (SELECT shipment_id FROM
  shipment_details sd WHERE shipment_date < ‘2023-01-01’ )
```

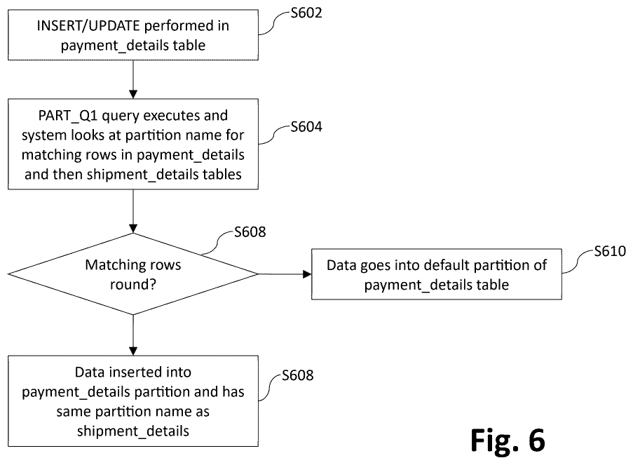

The database system will return results for this query. Because the partitions for the shipment_detail table entries are known to the system, based on a common column between the shipment_details table and the payment_details table, the database system knows which rows of the shipment_details table are in which partitions. Therefore, an insert/update operation for the payment_details table results in an insertion/update in the appropriate partition, namely, as indicated as in the shipment_details table or corresponding metadata. The basic flow is reflected in FIG. 6 and is as follows:
1. In step S602, an INSERT or UPDATE operation is executed on the payment_details table. The database system determines that the payment_details table is bound by QUERY partitioning.
2. The query for the payment_details table, along with the first subquery that is part of PART_Q1, are executed to determine to which partition(s) in shipment_details table the resulting rows belong, as indicated in steps S604 and S606.
3. In step S608, data is inserted/updated in appropriate partition names for the payment_details table when matches are found.
4. In step S610, rows that do not match the query PART_Q1 criteria are inserted in a default partition (e.g., p0).

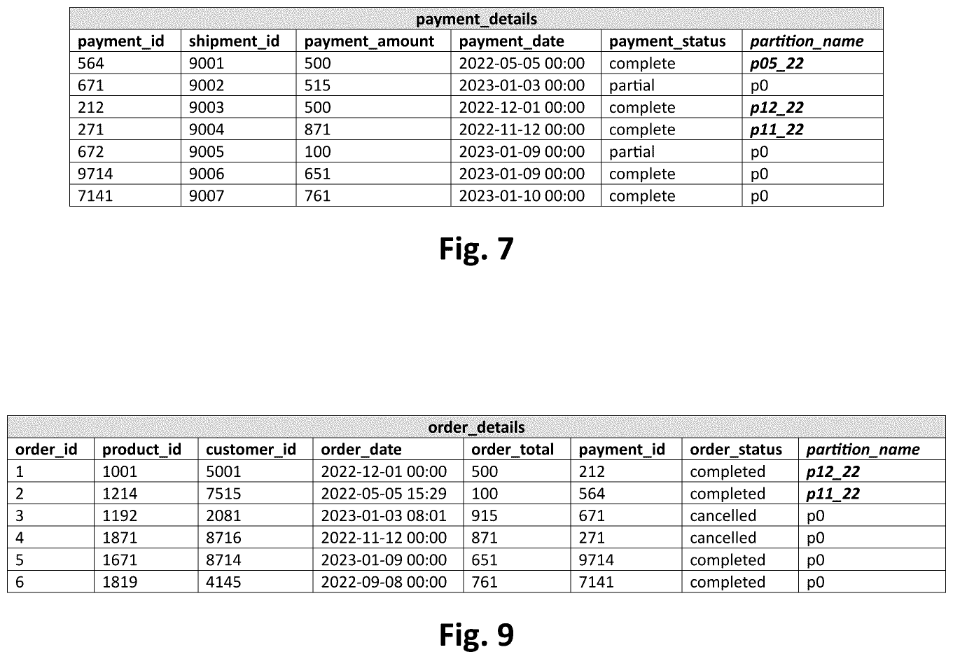

FIG. 7 shows the partitions for the payment_details table, with the matching and default partitions being shown. As above, the partition_name column is provided for illustration. In certain example embodiments, the database system may store partitioning-related metadata in system tables or the like and thus may know which row belongs to which partition based on this metadata without the use of an extra column. In certain example embodiments, however, a dedicated partition column similar to that shown in FIG. 7 may be provided.

Similarly, when data is inserted/updated in the order_details table, the query PART_Q1 will be executed to determine which partition each matching row belongs to for the shipment_details and payment_details tables. In this example, the following query is executed:

```
SELECT *FROM order_details od WHERE order_status = ‘completed’ AND
  payment_id IN (SELECT payment_id FROM payment_details pd WHERE
  pd.payment_status = ‘complete’ AND shipment_id IN (SELECT
  shipment_id FROM shipment_details sd WHERE shipment_details < ‘2023-
  01-01’ )
```

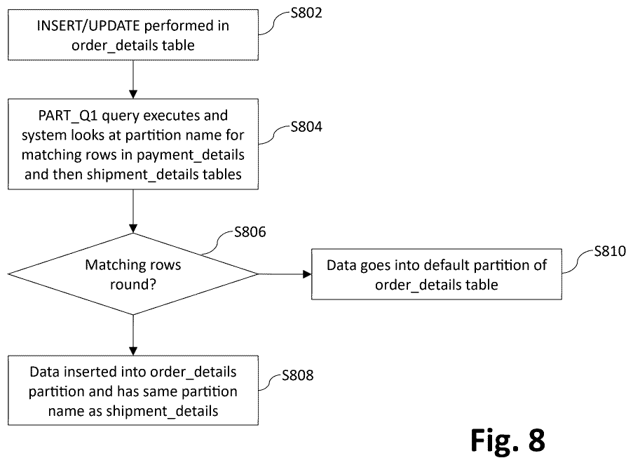

The basic flow is reflected in FIG. 8 and is as follows:

1. In step S802, an INSERT or UPDATE operation is executed on the order_details table. The database system determines that the order_details table is bound by QUERY partitioning.

2. The query for the order_details table, along with the subqueries that are part of PART_Q1, are executed to determine to which partition(s) in payment_details and shipment_details tables the resulting rows belong, as indicated in steps S804 and S806.

3. In step S808, data is inserted/updated in appropriate partition names for the order_details table when matches are found.

4. In step S810, rows that do not match the query PART_Q1 criteria are inserted in a default partition (e.g., p0).

Sample data for the order_details table based on this processing is given in FIG. 9. As above, the partition_name column is provided for illustration. In certain example embodiments, the database system may store partitioning-related metadata in system tables or other structures and thus may know which row belongs to which partition based on this metadata without the use of an extra column. In certain example embodiments, however, a dedicated partition column similar to that shown in FIG. 9 may be provided.

A partition-level operation performed on the shipment_details table automatically propagates to the payment_details and order_details tables, as appropriate, by using parameter cascading in the query_partition. The database system maintains the partition names across the tables and, therefore, any partition-level operations such as, for example, EXCHANGE PARTITIONS, TRUNCATE PARTITIONS, etc., automatically cascade to each table involved in query PART_Q1.

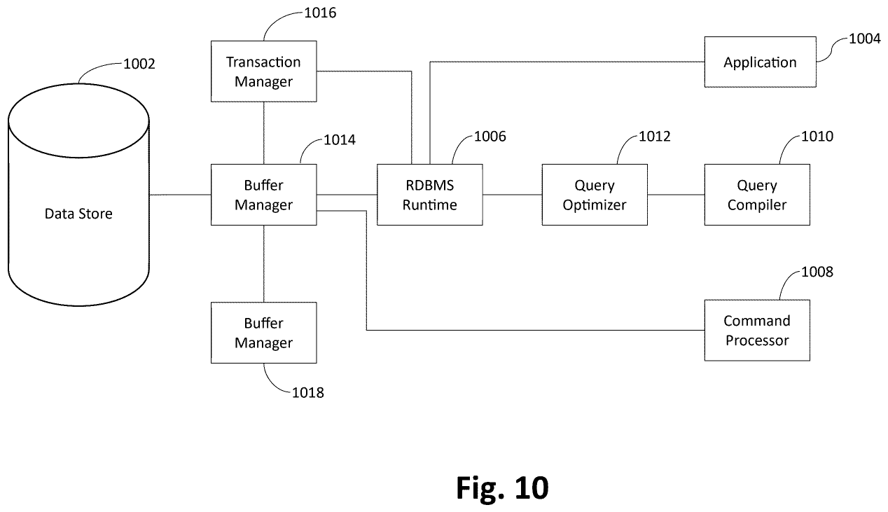

FIG. 10 is a block diagram including an example RDBMS that may be used in connection with certain example embodiments. Data, metadata, configuration files, system tables, logs, and/or the like, are stored in a data store 1002. The data store 1002 may be supported by any suitable non-transitory computer readable storage media such as, for example, solid state drives (SSDs), hard disk drives (HDDs), memory, and/or the like. Data from the data store 1002, for example, is accessed by an application 1004 via an RDBMS runtime system 1006. The application 1004 may be a compiled program, web application, or the like.

A database administrator (DBA) sets up the structure of the database using a command processor 1008. Frequently, the DBA will use a language like the Data Definition Language (DDL) to create or drop tables, add columns, etc. The DBA also can use other commands to set access controls, etc. The command processor 1008 may be a computer terminal and thus may including processing resources such as at least one processor and a memory, and user interface devices such as keyboards, mice, and the like, may be used to provide the commands from the DBA. In certain example embodiments, the computer terminal/command processor 1008 is used to define the query, the Primary Table, the one or more secondary tables, etc. Furthermore, create table statements and the like can be defined in multiple ways such as, for example, by hand-coded SQL statements, using a wizard with provided graphical user interface (GUI) tools, etc.

The RDBMS runtime system 1006 executes queries provided by a data analyst in SQL or other suitable language (e.g., as compiled by a query compiler 1010 and optimized by a query optimizer 1012). Similarly, the RDBMS runtime system 1006 handles queries from the application 1004. To this end, the RDBMS runtime system 1006 may be a computing system such as, for example, a standalone computer, distributed computing system (e.g., in a cloud computing environment), and/or the like. It may include processing resources such as a memory, hardware processors, etc. Queries from the application 1004 may be compiled and optimized, or correspond to queries from the data analyst that are compiled and optimized and stored, e.g., to the data store 1002. Compiled and optimized queries may be stored to the data store by the RDBMS runtime system 1006.

The RDBMS runtime system 1006 also interacts with a buffer manager 1014 and a transaction manager 1016. The buffer manager 1014 temporarily stores data from/for the database in main memory, for example, and uses a paging algorithm or the like so that operations can be performed faster and so as to help manage disk space utilization. The transaction manager 1016 manages tasks. The logs in a system may record information about transactions and may, for example, facilitate recovery operations and/or the like, e.g., in connection with the recover manager 1018.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing a database stored to a data store, the method comprising:
receiving a definition of a partitioning scheme, the definition of the partitioning scheme having associated therewith a partitioning scheme identifier, a partition-defining query, and an indication of a primary table to be partitioned;
receiving a definition of a first table, the first table being the primary table, the definition of the first table having associated therewith at least first and second partition types by which the first table is to be partitioned, the second partition type being a query type for which the partitioning scheme identifier is passed as a parameter;
receiving a definition of one or more second tables, each said second table being defined so as to have associated therewith a partition type by which the respective second table is to be partitioned, the partition type of each said second table being a query type for which the partitioning scheme identifier is passed as a parameter,
wherein the partition-defining query includes one or more outer queries conditioned on an innermost query, the innermost query being a query on the first table, each of the one or more outer queries being a query on a table in the database other than the first table;
partitioning the first table based on the first partition type; and
updating the database in response to an operation performed thereon, wherein the updating includes making a change to a partition of the first table and to a partition of each said second table based on an outcome of the partition-defining query.

2. The method of claim 1, wherein the first partition type is a range or list type partition.

3. The method of claim 1, wherein two or more second tables are included in the database, and wherein the partition-defining query is nested such that a first outcome of a first query on one of the second tables is conditioned on an outcome of the innermost query, and such that a second outcome on a second query on another one of the second tables is conditioned on the first outcome.

4. The method of claim 1, wherein each definition of each first table is provided in a respective create table statement.

5. The method of claim 1, wherein changes are made to the second table(s) provided that a flag indicates that changes are to be cascaded thereto.

6. The method of claim 1, wherein the operation is an insert or update data operation.

7. The method of claim 1, wherein the operation is an archive and/or purge operation where at least some data from the first and second tables is to be archived and/or purged.

8. The method of claim 7, wherein a first set of data is to be archived and/or purged from a first partition of the first table and a second set of data is to be archived and/or purged from a counterpart partition of the second table(s).

9. A non-transitory computer readable storage medium storing instructions that, when executed by at least one processor, perform operations comprising:
receiving a definition of a partitioning scheme for a database, the definition of the partitioning scheme having associated therewith a partitioning scheme identifier, a partition-defining query, and an indication of a primary table to be partitioned;
receiving a definition of a first table, the first table being the primary table, the definition of the first table having associated therewith at least first and second partition types by which the first table is to be partitioned, the second partition type being a query type for which the partitioning scheme identifier is passed as a parameter;
receiving a definition of one or more second tables, each said second table being defined so as to have associated therewith a partition type by which the respective second table is to be partitioned, the partition type of each said second table being a query type for which the partitioning scheme identifier is passed as a parameter,
wherein the partition-defining query includes one or more outer queries conditioned on an innermost query, the innermost query being a query on the first table, each of the one or more outer queries being a query on a table in the database other than the first table;
partitioning the first table based on the first partition type; and
updating the database in response to an operation performed thereon, wherein the updating includes making a change to a partition of the first table and to a partition of each said second table based on an outcome of the partition-defining query.

10. The non-transitory computer readable storage medium of claim 9, wherein the first partition type is a range or list type partition.

11. The non-transitory computer readable storage medium of claim 9, wherein two or more second tables are included in the database, and wherein the partition-defining query is nested such that a first outcome of a first query on one of the second tables is conditioned on an outcome of the innermost query, and such that a second outcome on a second query on another one of the second tables is conditioned on the first outcome.

12. The non-transitory computer readable storage medium of claim 9, wherein changes are made to the second table(s) provided that a flag indicates that changes are to be cascaded thereto.

13. The non-transitory computer readable storage medium of claim 9, wherein the operation is an archive and/or purge operation where at least some data from the first and second tables is to be archived and/or purged.

14. The non-transitory computer readable storage medium of claim 13, wherein a first set of data is to be archived and/or purged from a first partition of the first table and a second set of data is to be archived and/or purged from a counterpart partition of the second table(s).

15. A data management system, comprising:
a data store;
a database stored to the data store; and
a memory coupled to at least one hardware processor configured to perform operations comprising:
receiving a definition of a partitioning scheme for the database, the definition of the partitioning scheme having associated therewith a partitioning scheme identifier, a partition-defining query, and an indication of a primary table to be partitioned;
receiving a definition of a first table, the first table being the primary table, the definition of the first table having associated therewith at least first and second partition types by which the first table is to be partitioned, the second partition type being a query type for which the partitioning scheme identifier is passed as a parameter;
receiving a definition of one or more second tables, each said second table being defined so as to have associated therewith a partition type by which the respective second table is to be partitioned, the partition type of each said second table being a query type for which the partitioning scheme identifier is passed as a parameter,
wherein the partition-defining query includes one or more outer queries conditioned on an innermost query, the innermost query being a query on the first table, each of the one or more outer queries being a query on a table in the database other than the first table;
partitioning the first table based on the first partition type; and
updating the database in response to an operation performed thereon, wherein the updating includes making a change to a partition of the first table and to a partition of each said second table based on an outcome of the partition-defining query.

16. The system of claim 15, wherein the first partition type is a range or list type partition.

17. The system of claim 15, wherein two or more second tables are included in the database, and wherein the partition-defining query is nested such that a first outcome of a first query on one of the second tables is conditioned on an outcome of the innermost query, and such that a second outcome on a second query on another one of the second tables is conditioned on the first outcome.

18. The system of claim 15, wherein changes are made to the second table(s) provided that a flag indicates that changes are to be cascaded thereto.

19. The system of claim 15, wherein the operation is an archive and/or purge operation where at least some data from the first and second tables is to be archived and/or purged.

20. The system of claim 19, wherein a first set of data is to be archived and/or purged from a first partition of the first table and a second set of data is to be archived and/or purged from a counterpart partition of the second table(s).
